(19) United States
(12) Patent Application Publication
(10) Pub. No.: US 2026/0074253 A1
(43) Pub. Date: Mar. 12, 2026

(54) MEMBRANE-ELECTRODE ASSEMBLY FOR HIGH-TEMPERATURE POLYMER ELECTROLYTE MEMBRANE FUEL CELL IN CATALYST-COATED MEMBRANE FORM AND METHOD FOR MANUFACTURING SAME

(71) Applicants: Hyundai Motor Company, Seoul (KR); Kia Corporation, Seoul (KR)

(72) Inventors: Songi Oh, Gyeonggi-do (KR); Won Jae Choi, Gyeonggi-do (KR); So Hwa Kim, Gyeonggi-do (KR); Sung Hee Shin, Gyeonggi-do (KR); Ah Hyeon Park, Gyeonggi-do (KR); Jee Youn Hwang, Gyeonggi-do (KR); Da Hee Kwak, Gyeonggi-do (KR)

(21) Appl. No.: 19/044,979

(22) Filed: Feb. 4, 2025

(30) Foreign Application Priority Data
Sep. 11, 2024 (KR) 10-2024-0123588

(51) Int. Cl. H01M 8/1004; H01M 8/10; H01M 8/1034; H01M 8/1067

(52) U.S. Cl. CPC H01M 8/1004; H01M 8/1034; H01M 8/1067; H01M 2008/1095

(57) ABSTRACT

A membrane-electrode assembly (MEA) for a polymer electrolyte membrane fuel cell is prepared by applying an electrode slurry onto a release sheet to form an electrode layer, providing an electrolyte membrane comprising a substrate doped with phosphoric acid, and transferring the electrode layer to create a catalyst-coated membrane (CCM). The electrode slurry contains a catalyst, ionomer(s), and a solvent, with a solid content of about 10-15% by weight. The release sheet, comprising polyimide and about 30-80 μm thick, allows uniform coating and transfer. The resulting electrolyte membrane, about 40-50 μm thick, is doped with about 5-9 mg/cm² of phosphoric acid and includes a hydrocarbon-based polymer substrate. The final MEA exhibits a high-frequency resistance of about 100 mΩ·cm² or less.

### CROSS-REFERENCE TO RELATED APPLICATION

This application claims under 35 U.S.C. § 119(a) the benefit of Korean Patent Application No. 10-2024-0123588 filed on Sep. 11, 2024, the entire contents of which are incorporated herein by reference.

### BACKGROUND

### Technical Field

The present disclosure relates to a method for manufacturing a membrane-electrode assembly for a high-temperature polymer electrolyte membrane fuel cell by a transfer method.

### Background

Polymer electrolyte membrane fuel cells (PEMFC) can be divided into low-temperature and high-temperature types. The difference between the two fuel cells is operating temperature and membrane type.

Low-temperature PEMFCs operate at about 60° C. to 80° C., and high-temperature PEMFCs operate at about 120° C. to 180° C.

Low-temperature PEMFCs use electrolyte membranes containing perfluorosulfonic acid-based ionomers such as Nafion, and high-temperature PEMFCs generally use electrolyte membranes containing polybenzimidazole-based ionomers doped with phosphoric acid. The electrolyte membranes containing perfluorosulfonic acid-based ionomers require water for conducting hydrogen ions, but the electrolyte membranes containing polybenzimidazole-based ionomers doped with phosphoric acid can conduct hydrogen ions even without water, making operation at or above 100° C. possible.

Meanwhile, a polymer electrolyte membrane fuel cell (PEMFC) includes a membrane-electrode assembly including an electrolyte membrane and a pair of electrode layers positioned on both surfaces of the electrolyte membrane, a gas diffusion layer (GDL) on the membrane-electrode assembly, a separator on the gas diffusion layer, etc.

The membrane-electrode assembly can be classified into a catalyst-coated GDL (CCG) type in which an electrode layer is coated on the gas diffusion layer (GDL) according to the manufacturing method to manufacture a laminate, and then the laminate is attached to the electrolyte membrane, and a catalyst-coated membrane (CCM) type in which the electrode layer is transferred to the electrolyte membrane. The catalyst-coated membrane (CCM) type is advantageous in terms of good interfacial bonding between the electrode layer and the electrolyte membrane, the utilization rate of the catalyst, etc.

In low-temperature PEMFCs, the electrode layer may be readily transferred to the electrolyte membrane since the electrolyte membrane is in a solid state. However, in high-temperature PEMFCs, the membrane is doped and/or impregnated with liquid phosphoric acid, making transfer more difficult and risking phosphoric acid leakage under elevated temperatures and pressure conditions. Consequently, membrane-electrode assemblies of the high-temperature PEMFCs are generally manufactured as a catalyst-coated gas diffusion layer (CCG).

### SUMMARY OF THE DISCLOSURE

An object of the present disclosure is to provide a membrane-electrode assembly for a high-temperature polymer electrolyte membrane fuel cell in the form of a catalyst-coated membrane (CCM) and a method for manufacturing the same.

The objects of the present disclosure are not limited to the object mentioned above. The objects of the present disclosure will become more apparent from the following description and will be realized by means and combinations thereof described in the claims.

A method for manufacturing a membrane-electrode assembly for a polymer electrolyte membrane fuel cell (e.g., a high-temperature polymer electrolyte membrane fuel cell) according to one embodiment of the present disclosure may include steps of: applying an electrode slurry onto a release sheet (e.g., paper) to manufacture a laminate including the release sheet and an electrode layer on the release sheet; providing an electrolyte membrane including a substrate and an electrolyte doped into the substrate; and transferring the electrode layer of the laminate onto the electrolyte membrane to manufacture a membrane-electrode assembly in the form of a catalyst-coated membrane (CCM).

The electrode slurry may include for example a catalyst; an ionomer; and a solvent component.

The electrode slurry may have a solid content concentration of 10% by weight to 15% by weight.

The ionomer may include at least one selected from the group consisting of a perfluorosulfonic acid-based ionomer, a partial fluorophosphate-based ionomer, and a combination thereof.

The solvent component may include at least one selected from the group consisting of: an alcohol-based organic solvent; at least one co-solvent selected from the group consisting of an amide-based organic solvent, a ketone-based organic solvent, a carbonate-based organic solvent, an ether-based organic solvent, and combinations thereof; and combinations thereof.

The release sheet may include polyimide.

The release sheet may have a thickness of 30 μm or more to less than 80 μm.

The electrode layer may have a thickness of 5.5 μm to 55 μm.

The substrate may have a binding energy for phosphoric acid of 100 kcal/mol or more.

The substrate may include at least one selected from the group consisting of phosphonated phenylated-poly(phenylene), phosphonated polynorbornene, phosphonated polycarbazole, and combinations thereof.

The electrolyte may include phosphoric acid.

The electrolyte membrane may be one in which the substrate is doped with the electrolyte in an amount of 5 mg/cm² to 9 mg/cm².

The electrolyte membrane may have a thickness of 40 μm to 50 μm.

The electrode layer of the laminate may be transferred to the electrolyte membrane at 120° C. to 140° C.

The electrode layer of the laminate may be transferred to the electrolyte membrane at a pressure of more than 3.89 MPa to 5.84 MPa or less.

A membrane-electrode assembly for a polymer electrolyte membrane fuel cell according to one embodiment of the present disclosure includes an electrolyte membrane; and an electrode layer on the electrolyte membrane, wherein the electrolyte membrane includes a substrate and an electrolyte doped into the substrate, and may be in the form of a catalyst-coated membrane (CCM).

The membrane-electrode assembly for a polymer electrolyte membrane fuel cell may have a high-frequency resistance (HFR) of 100 mΩ·cm² or less.

According to the present disclosure, a membrane-electrode assembly for a polymer electrolyte membrane fuel cell in the form of a catalyst-coated membrane (CCM) and a method for manufacturing the same can be obtained.

According to the present disclosure, polymer electrolyte membrane fuel cell having a good interface between the electrolyte membrane and the electrode layer, low contact resistance, and excellent performance can be obtained.

According to the present disclosure, a method for manufacturing a membrane-electrode assembly for a polymer electrolyte membrane fuel cell which is advantageous for mass production and easily controls the area and thickness of the electrode layer can be obtained.
As discussed, the method and system suitably include use of a controller or processer.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 illustrates a membrane-electrode assembly for a high-temperature polymer electrolyte membrane fuel cell according to the present disclosure.

FIG. 2 is a reference diagram for explaining the steps of manufacturing a laminate.

FIG. 3A shows that an electrode slurry containing only a partial fluorophosphate-based ionomer as an ionomer is applied onto a release paper.

FIG. 3B shows that an electrode slurry containing only N-methyl-2-pyrrolidone (NMP) as a solvent is applied onto a release paper.

FIG. 3C shows that an electrode slurry containing a perfluorosulfonic acid-based ionomer and a partial fluorophosphate-based ionomer as ionomers and n-propyl alcohol (nPA) and N-methyl-2-pyrrolidone (NMP) as solvents is applied onto a release paper.

FIG. 4 shows that an electrode layer is transferred using polyethylene naphthalate (PEN) as a release paper.

FIG. 5 shows that an electrode layer is transferred by using a release paper (left) containing polyimide and having a thickness of 30 μm and using a release paper (right) containing polyimide and having a thickness of 80 μm.

FIG. 6A shows that an electrode layer is transferred to an electrolyte membrane having a doping amount of phosphoric acid of 9 mg/cm².

FIG. 6B shows that an electrode layer is transferred to an electrolyte membrane having a doping amount of phosphoric acid of 7 mg/cm².

FIG. 7 is a reference diagram for explaining that the electrode layer of the laminate is transferred to the electrolyte membrane.

FIG. 8A shows that an electrode layer is transferred to the electrolyte membrane under the conditions of 120° C. and 1.62 MPa.

FIG. 8B shows that an electrode layer is transferred to the electrolyte membrane under the conditions of 120° C. and 3.24 MPa.

FIG. 8C shows that an electrode layer is transferred to the electrolyte membrane under the conditions of 120° C. and 3.89 MPa.

FIG. 8D shows that an electrode layer is transferred to the electrolyte membrane under the conditions of 120° C. and 4.86 MPa.

FIG. 9 shows results of analyzing a membrane-electrode assembly in the form of a catalyst-coated membrane (CCM) according to the present disclosure with a field emission scanning electron microscope (FE-SEM).

FIG. 10 shows results of analyzing a membrane-electrode assembly in the form of a catalyst-coated gas diffusion layer (CCG) with a field emission scanning electron microscope (FE-SEM).

FIG. 11 shows results of measuring phosphoric acid outflow amounts of a membrane-electrode assembly in the form of a catalyst-coated membrane (CCM) according to the present disclosure.

FIG. 12 shows results of measuring performance of a membrane-electrode assembly in the form of a catalyst-coated membrane (CCM) according to the present disclosure.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, dimensions of the structures are enlarged from the actual size for clarity of the present disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part, but also the case where there is another part in the middle therebetween. Conversely, when a part of a layer, film, region, plate, etc. is said to be “under” other part, this includes not only the case where it is “directly under” the other part, but also the case where there is another part in the middle therebetween.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous, and includes all values from a minimum value of such a range to the maximum value including a maximum value, unless otherwise indicated. Furthermore, when such a range refers to an integer, all integers including from the minimum value to the maximum value including a maximum value are included, unless otherwise indicated.

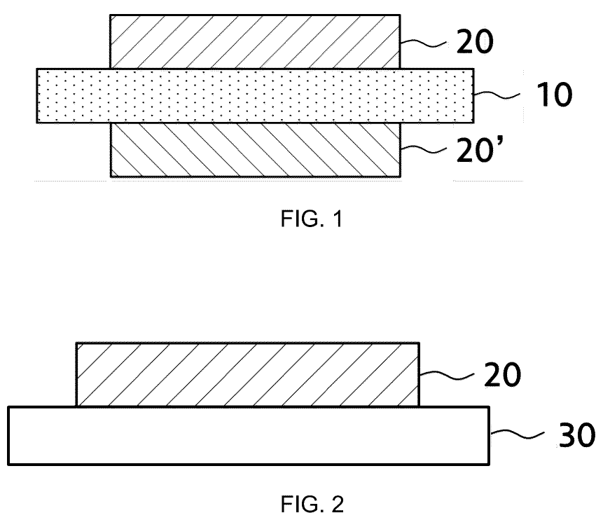

FIG. 1 illustrates a membrane-electrode assembly for a high-temperature polymer electrolyte membrane fuel cell according to the present disclosure. The membrane-electrode assembly may include an electrolyte membrane 10 and electrode layers 20 and 20′ on the electrolyte membrane 10. When the electrode layer 20 on one surface of the electrolyte membrane 10 is a cathode, the electrode layer 20′ on the other surface may be an anode.

The membrane-electrode assembly may be in the form of a catalyst-coated membrane (CCM). The catalyst-coated membrane form may mean that the electrode layers 20 and 20′ are attached to the electrolyte membrane 10 in a series of ways and integrated. Specifically, the electrode layers 20 and 20′ may be transferred to both surfaces of the electrolyte membrane 10.

The method for manufacturing a membrane-electrode assembly for a high-temperature polymer electrolyte membrane fuel cell according to the present disclosure may include steps of manufacturing a laminate including a release paper and an electrode layer on the release paper, preparing an electrolyte membrane, and transferring the electrode layer of the laminate to the electrolyte membrane to manufacture a membrane-electrode assembly in the form of a catalyst-coated membrane (CCM).

FIG. 2 is a reference diagram for explaining the steps of manufacturing a laminate. The laminate may be obtained by applying an electrode slurry on a release paper 30 to form an electrode layer 20 on the release paper 30.

The electrode slurry may contain for example a catalyst, an ionomer, and a solvent.

The catalyst may include platinum supported on a carbon support (Pt/C), etc. The content of platinum is not particularly limited, and may be, for example, about 40% by weight to 60% by weight based on the total weight of the catalyst.

The ionomer may include a perfluorosulfonic acid-based ionomer or a partial fluorophosphate-based ionomer, and preferably a perfluorosulfonic acid-based ionomer and a partial fluorophosphate-based ionomer. The perfluorosulfonic acid-based ionomer is an ionomer whose hydrogen ion conductive group is a sulfonic acid group, and a main chain thereof may be polytetrafluoroethylene (PTFE), and a side chain thereof may include a sulfonic acid group (—SO₃H), and preferably Nafion. The partial fluorophosphate-based ionomer is an ionomer whose hydrogen ion conductive group is a phosphate group (—PH₂O₃), and may include poly(2,3,5,6-tetrafluorostyrene-4-phosphonic acid), a compound represented by Formula 1 below, etc.

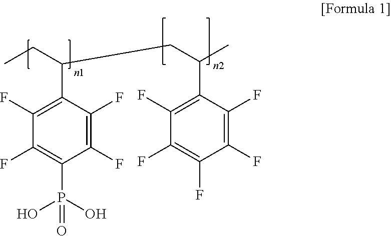

In Formula 1, n1 is 0.7a, n2 is 0.3a, and a may be a number belonging to 100 to 10,000.

The ionomer may include the perfluorosulfonic acid-based ionomer and the partial fluorophosphate-based ionomer at a mass ratio of 3:7 to 5:5, or 4:6. When the mass ratio of the ionomer falls within the above numerical range, the electrode slurry has excellent dispersibility, and the electrode slurry may be uniformly applied onto the release paper.

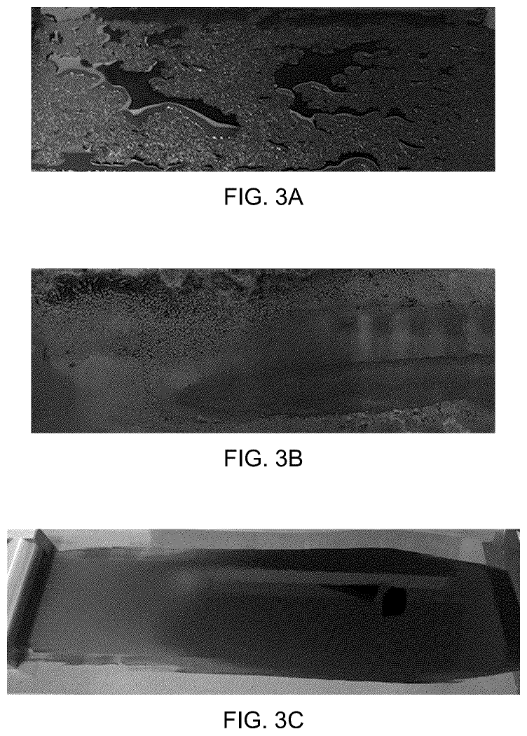

FIG. 3A shows that an electrode slurry containing only a partial fluorophosphate-based ionomer as an ionomer is applied onto a release paper. Referring to this, it can be seen that the electrode slurry cannot be uniformly applied onto the release paper when only the partial fluorophosphate-based ionomer is used.

The solvent may include a hydrophilic solvent to lower the bonding strength with the release paper but increase the bonding strength with the electrolyte membrane. Specifically, the solvent may include at least one selected from the group consisting of: an alcohol-based organic solvent; at least one cosolvent selected from the group consisting of an amide-based organic solvent, a ketone-based organic solvent, a carbonate-based organic solvent, an ether-based organic solvent, and combinations thereof; and combinations thereof. In order to increase the dispersibility of the ionomer, the cosolvent may be mixed with the alcohol-based organic solvent, and preferably, the alcohol-based organic solvent and the amide-based organic solvent may be mixed and used.

The alcohol-based organic solvent may include an alcohol having 1 to 4 carbon atoms, preferably n-propyl alcohol (nPA).

The amide-based organic solvent may include formamide (FA), N-methyl formamide (NMFA), N,N-dimethyl formamide (DMF), acetamide (AA), N-methyl acetamide (NMAA), N,N-dimethyl acetamide (DMA), N-methyl-2-pyrrolidone (NMP), etc., preferably N-methyl-2-pyrrolidone (NMP).

The ketone-based organic solvent may include acetone, methylethylketone (MEK), methylbutylketone (MBK), methylisobutylketone (MIBK), etc.

The carbonate-based organic solvent may include ethylene carbonate, propylene carbonate, 1,2-butylene carbonate, 2,3-butylene carbonate, 1,2-pentylene carbonate, 2,3-pentylene carbonate, vinylene carbonate, dimethyl carbonate, diethyl carbonate, dipropyl carbonate, ethylmethyl carbonate (EMC), methylpropyl carbonate, ethylpropyl carbonate, etc.

The ether-based organic solvent may include ethylene glycol dimethyl ether, ethylene glycol diethyl ether, ethylene glycol dipropyl ether, ethylene glycol dibutyl ether, propylene glycol dimethyl ether, propylene glycol diethyl ether, propylene glycol dibutyl ether, diethylene glycol dimethyl ether, diethylene glycol methyl ethyl ether, diethylene glycol diethyl ether, 1,4-dioxane, tetrahydrofuran, anisole, etc.

FIG. 3B shows that an electrode slurry containing only N-methyl-2-pyrrolidone (NMP) as a solvent is applied onto a release paper. Referring to this, it can be seen that the electrode slurry cannot be uniformly applied onto the release paper if only N-methyl-2-pyrrolidone (NMP) above is used.

FIG. 3C shows that an electrode slurry containing a perfluorosulfonic acid-based ionomer and a partial fluorophosphate-based ionomer as ionomers and n-propyl alcohol (nPA) and N-methyl-2-pyrrolidone (NMP) as solvents is applied onto a release paper. Referring to this, it can be seen that the electrode slurry can be uniformly applied onto a release paper only when the ionomer and the solvent are used in combination as in the present disclosure.

The electrode slurry may have a solid content concentration of 10% by weight to 15% by weight. The solid content concentration may mean the content of solid components such as a catalyst, an ionomer, etc. excluding the content of the solvent in the electrode slurry. If the solid content concentration is less than 10% by weight, the viscosity is low, making it difficult to coat the release paper with the electrode slurry, and the content of the catalyst may be low. If the concentration of the solid content exceeds 15% by weight, the catalyst and ionomer may be lumped together to make it difficult to coat the release paper with the electrode slurry and the formation of a three-phase interface may be unfavorable.

A method for preparing the electrode slurry is not particularly limited, and for example, the electrode slurry may be prepared by introducing a catalyst and an ionomer into a solvent, mixing them with a paste mixer for about 30 minutes, dispersing them with a high-shear homogenizer for about 60 minutes, and defoaming them for about 20 minutes.

The release paper 30 may include polyimide. When using polyimide, the bonding strength between the electrode layer 20 and the release paper 30 is lowered so that the electrode layer 20 may be neatly transferred onto the electrolyte membrane 10.

The release paper 30 may have a thickness of 30 μm or more to less than 80 μm. If the thickness of the release paper 30 is less than 30 μm, the workability deteriorates, and if it is 80 μm or more, it may not be suitable for the transfer process.

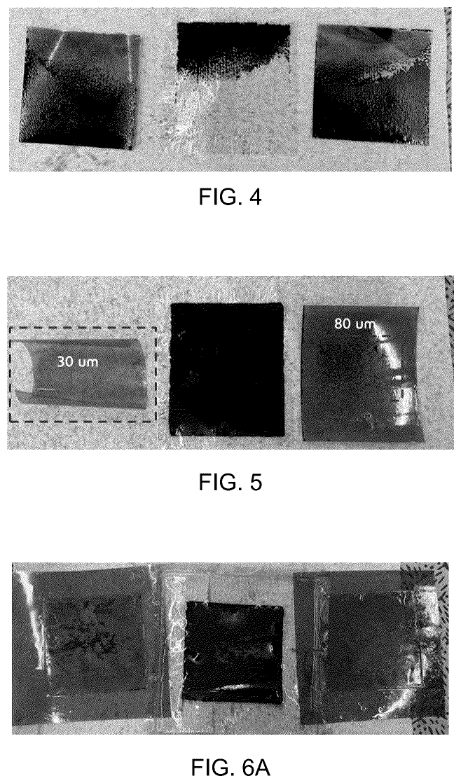

FIG. 4 shows that an electrode layer is transferred using polyethylene naphthalate (PEN) as a release paper. Referring to this, it can be seen that a considerable amount of residue of the electrode layer remains on the release paper.

FIG. 5 shows that an electrode layer is transferred by using a release paper (left) containing polyimide and having a thickness of 30 μm and using a release paper (right) containing polyimide and having a thickness of 80 μm. Referring to this, it can be seen that when a release paper which has a thickness of 30 μm and is formed of polyimide is used, the electrode layer can be transferred cleanly, but when the thickness increases to 80 μm, a considerable amount of residue of the electrode layer remains on the release paper.

In the present disclosure, since the electrode layer 20 is formed on a release paper 30 instead of a gas diffusion layer, and the electrode layer 20 is transferred to the electrolyte membrane 10, it is easy to control the thickness of the electrode layer 20. When the electrode slurry is applied to the gas diffusion layer to form the electrode layer 20, a portion of the electrode slurry penetrates into the gas diffusion layer so that it may be difficult to control the thickness of the electrode layer 20, and the surface of the electrode layer 20 cannot be controlled.

The electrode layer 20 may have a thickness of 5.5 μm to 55 μm, and the thickness may be controlled depending on the loading amount of the catalyst. For example, when the loading amount of the catalyst is 0.15 mg/cm² to 0.35 mg/cm², the electrode layer 20 may have a thickness of 5.5 μm to 19.5 μm. When the loading amount of the catalyst is 0.35 mg/cm² to 0.7 mg/cm², the electrode layer 20 may have a thickness of 19.5 μm to 38.5 μm. When the loading amount of the catalyst is 0.7 mg/cm² to 1.0 mg/cm², the electrode layer 20 may have a thickness of 38.5 μm to 54.0 μm.

The electrolyte membrane 10 may include a substrate and an electrolyte doped into the substrate. The substrate may have a sheet form and may be porous. Here, “doping” may mean that the electrolyte is impregnated into the interior of the porous substrate.

The substrate may have hydrogen ion conductivity.

In addition, the substrate may have a binding energy for phosphoric acid of 100 kcal/mol or more in order to prevent outflow of the electrolyte after the transfer process. The binding energy may be derived by density foundational theory calculations using ωB97XD functional and 6-311++G (2d,2p) as a basis set.

The substrate satisfying the above conditions may include a hydrocarbon-based polymer having a quaternary ammonium group introduced therein, and specifically may include at least one selected from the group consisting of phosphonated phenylated-poly (phenylene), phosphonated polynorbornene, phosphonated polycarbazole, and combinations thereof.

Phosphonated phenylated-poly(phenylene) above may include a compound represented by Formula 2 below.

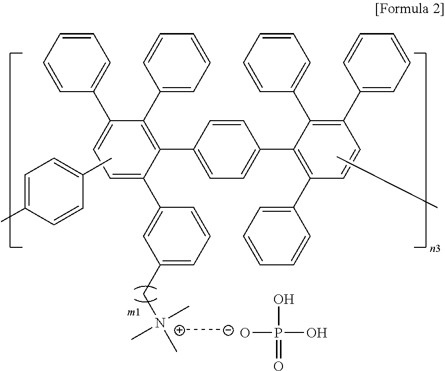

In Formula 2, n3 may be a number belonging to 100 to 10,000, and m1 may be a number belonging to 2 to 10.

Phosphorylated polynorbornene above may include a compound represented by Formula 3 below.

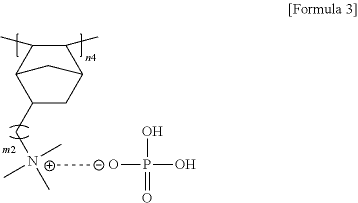

In Formula 3, n4 may be a number belonging to 100 to 10,000, and m2 may be a number belonging to 2 to 10.

Phosphorylated polycarbazole above may include a compound represented by Formula 4 below.

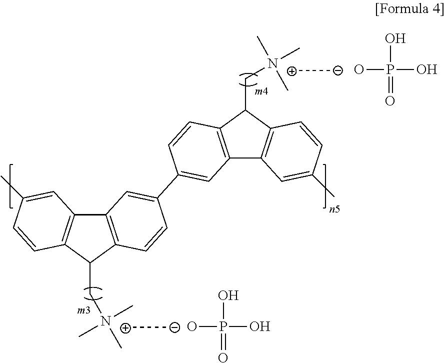

In Formula 4, n5 is a number belonging to 100 to 10,000, and m3 and m4 may be numbers belonging to 2 to 10, respectively.

The electrolyte may include phosphoric acid. Phosphoric acid may be in a liquid state.

The electrolyte membrane 10 may be obtained by doping the substrate with the electrolyte in an amount of 5 mg/cm² to 9 mg/cm², preferably 5 mg/cm² to 8 mg/cm², and more preferably 5 mg/cm² to 7 mg/cm². If the doping amount of the electrolyte is less than 5 mg/cm², the performance of the fuel cell may deteriorate, and if it exceeds 9 mg/cm², the electrode layer 20 may not be transferred cleanly.

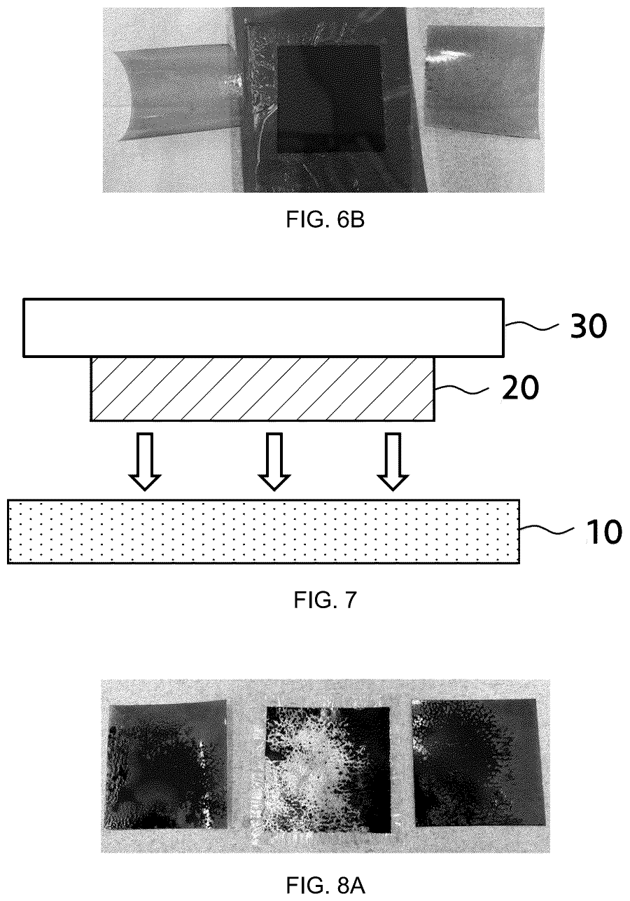

FIG. 6A shows that an electrode layer is transferred to an electrolyte membrane having a doping amount of phosphoric acid of 9 mg/cm². Referring to this, it can be seen that the electrolyte membrane 10 is soaked in an excessive amount of phosphoric acid so that the electrode layer 20 is not completely transferred and a portion of it remains on the release paper 30.

FIG. 6B shows that an electrode layer is transferred to an electrolyte membrane having a doping amount of phosphoric acid of 7 mg/cm². Referring to this, it can be seen that the electrode layer 20 is cleanly transferred to the electrolyte membrane 10.

The thickness of the electrolyte membrane 10 is not particularly limited and may be, for example, 40 μm to 50 μm. When the thickness of the electrolyte membrane 10 falls within the above numerical range, the workability is excellent, and the performance of the fuel cell may be increased.

FIG. 7 is a reference diagram for explaining that the electrode layer 20 of the laminate is transferred to the electrolyte membrane 10. A membrane-electrode assembly in the form of a catalyst-coated membrane (CCM) may be manufactured by transferring the electrode layer 20 to the electrolyte membrane 10 by applying a predetermined amount of heat and pressure after attaching the laminate to the electrolyte membrane 10 so that the electrode layer 20 of the laminate faces the electrolyte membrane 10.

Specifically, the electrode layer 20 may be transferred to the electrolyte membrane 10 under the conditions of 120° C. to 140° C.; and more than 3.89 MPa to 5.84 MPa or less. When the temperature conditions of the transfer fall within the above numerical range, the electrolyte doped in the electrolyte membrane 10 may be moved to the electrode layer 20 while sufficiently removing moisture. If the transfer pressure is 3.89 MPa or less, the electrode layer 20 may not be transferred cleanly, and if the transfer pressure exceeds 5.84 MPa, there is a possibility that the electrolyte may flow out.

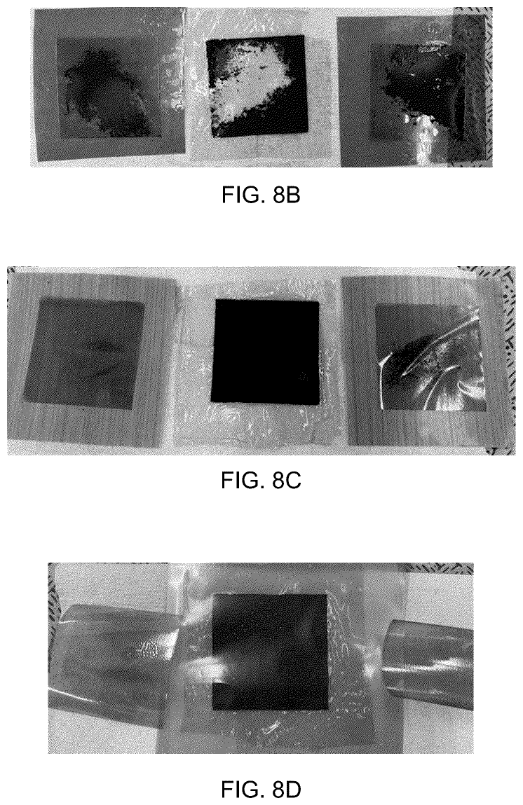

FIG. 8A shows that an electrode layer 20 is transferred to the electrolyte membrane 10 under the conditions of 120° C. and 1.62 MPa. FIG. 8B shows that an electrode layer 20 is transferred to the electrolyte membrane 10 under the conditions of 120° C. and 3.24 MPa. FIG. 8C shows that an electrode layer 20 is transferred to the electrolyte membrane 10 under the conditions of 120° C. and 3.89 MPa. Referring to this, it can be seen that when the transfer pressure is 3.89 MPa or less, the electrode layer 20 is not cleanly transferred to the electrolyte membrane 10.

FIG. 8D shows that an electrode layer 20 is transferred to the electrolyte membrane 10 under the conditions of 120° C. and 4.86 MPa. It can be confirmed that when the temperature and pressure conditions of the transfer are the same as those of the present disclosure, the electrode layer 20 is well transferred to the electrolyte membrane 10.

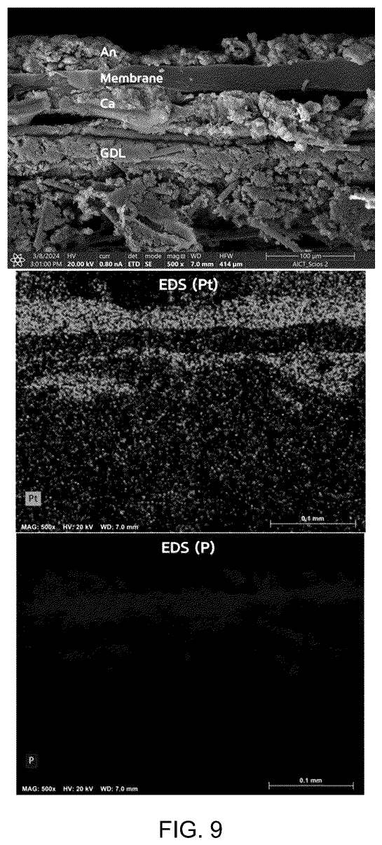

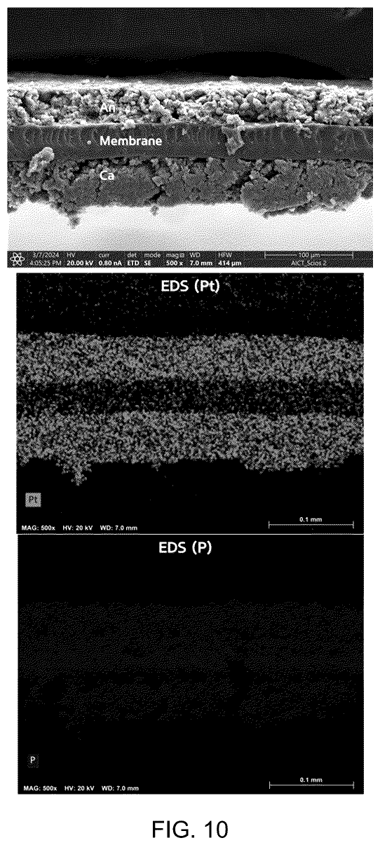

FIG. 9 shows results of analyzing a membrane-electrode assembly in the form of a catalyst-coated membrane (CCM) according to the present disclosure with a field emission scanning electron microscope (FE-SEM). FIG. 10 shows results of analyzing a membrane-electrode assembly in the form of a catalyst-coated gas diffusion layer (CCG) with a field emission scanning electron microscope (FE-SEM).

Referring to FIG. 10, it can be seen that since the electrode layer is coated on a gas diffusion layer of which surface is uneven, the membrane-electrode assembly in the form of a catalyst-coated gas diffusion layer (CCG) has a large thickness deviation of the electrode layer, and the adhesion between the electrolyte membrane and the electrode layer is lowered. In addition, it can be seen from the platinum (Pt) results of energy-dispersive X-ray spectroscopy (EDS) that platinum has permeated into the gas diffusion layer, which reduces the utilization rate of the catalyst and makes the thickness uneven. It can be confirmed from the phosphorus (P) analysis results that the movement of phosphoric acid, which is an electrolyte, from the electrolyte membrane to the electrode layer is not uniform.

Referring to FIG. 9, the membrane-electrode assembly in the form of a catalyst-coated membrane (CCM) has a small thickness deviation of the electrode layer, and the interface bonding between the electrolyte membrane and the electrode layer is very good. The platinum (Pt) analysis results of energy-dispersive X-ray spectroscopy (EDS) show that the electrode layer is very uniform. Additionally, it can be confirmed from the phosphorus (P) analysis results that phosphoric acid, which is the electrolyte, moves uniformly throughout the membrane-electrode assembly.

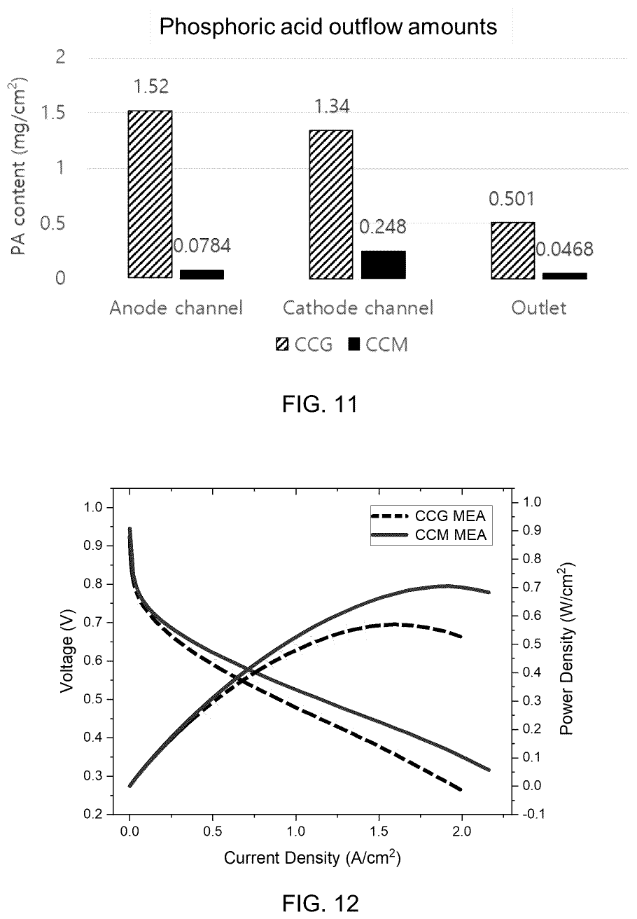

FIG. 11 shows results of measuring phosphoric acid outflow amounts of a membrane-electrode assembly in the form of a catalyst-coated membrane (CCM) according to the present disclosure. For comparison, the phosphoric acid outflow amount of a membrane-electrode assembly in the form of a catalyst-coated gas diffusion layer (CCG) is also shown. Specifically, the amount of phosphoric acid that escaped through the gas diffusion layer while operating the cell for 6 hours was measured at the anode channel, cathode channel, and outlet, respectively. Referring to FIG. 11, the phosphoric acid outflow amount of the membrane-electrode assembly in the form of a catalyst-coated membrane (CCM) according to the present disclosure is significantly small. In addition, in the membrane-electrode assembly in the form of a catalyst-coated gas diffusion layer (CCG), phosphoric acid that has penetrated into the gas diffusion layer is not used as an electrolyte and is flown out during cell operation.

FIG. 12 shows results of measuring performance of a membrane-electrode assembly in the form of a catalyst-coated membrane (CCM) according to the present disclosure. For comparison, the performance of a membrane-electrode assembly in the form of a catalyst-coated gas diffusion layer (CCG) is also shown. Specifically, the IV performance of each cell was evaluated under the conditions of 160° C., a hydrogen flow rate of 500 sccm, an oxygen flow rate of 2,500 sccm, and a pressure of 1.5 bar. Peak power density (PPD) which is a performance index, and high-frequency resistance (HFR) which is a contact resistance index, are shown in Table 1 below.

TABLE 1

| Item | PPD [W/cm²] | HFR [mΩ · cm²] |
|---|---|---|
| CCM | 0.705 | 94 |
| CCG | 0.570 | 140 |

Referring to FIG. 12 and Table 1, it can be seen that since the electrode layer is uniformly transferred on the electrolyte membrane, the membrane-electrode assembly in the form of a catalyst-coated membrane (CCM) according to the present disclosure has a low contact resistance between the electrolyte membrane and the electrode layer and excellent performance. Specifically, it is characterized by the contact resistance index HFR being 100 mΩ·cm² or less.

Although the embodiments of the present disclosure have been described above, those skilled in the art to which the present disclosure pertains will understand that the present disclosure can be implemented in other specific forms without changing the technical idea or essential features thereof. Therefore, it should be understood that the embodiments described above are exemplary in all aspects and not limiting.

What is claimed is:

1. A method for manufacturing a membrane-electrode assembly for a polymer electrolyte membrane fuel cell, the method comprising:
applying an electrode slurry onto a release sheet to manufacture a laminate comprising the release sheet and an electrode layer on the release sheet;
providing an electrolyte membrane comprising a substrate and an electrolyte doped into the substrate; and
transferring the electrode layer of the laminate onto the electrolyte membrane to manufacture a membrane-electrode assembly in the form of a catalyst-coated membrane (CCM).

2. The method of claim 1, wherein the electrode slurry comprises a catalyst; an ionomer; and a solvent component.

3. The method of claim 1, wherein the electrode slurry has a solid content concentration of about 10% by weight to 15% by weight.

4. The method of claim 2, wherein the ionomer comprises a perfluorosulfonic acid-based ionomer, a partial fluorophosphate-based ionomer, or a combination thereof.

5. The method of claim 2, wherein the solvent component comprises an alcohol-based organic solvent; at least one co-solvent selected from the group consisting of an amide-based organic solvent, a ketone-based organic solvent, a carbonate-based organic solvent, an ether-based organic solvent, and a combination thereof; or a combination thereof.

6. The method of claim 1, wherein the release sheet comprises polyimide.

7. The method of claim 1, wherein the release sheet has a thickness of 30 μm or more to less than about 80 μm.

8. The method of claim 1, wherein the substrate comprises a hydrocarbon-based polymer having a quaternary ammonium group, optionally one selected from the group consisting of phosphonated phenylated-poly(phenylene), phosphonated polynorbornene, phosphonated polycarbazole, and a combination thereof.

9. The method of claim 1, wherein the electrolyte comprises phosphoric acid.

10. The method of claim 1, wherein the electrolyte membrane is one in which the substrate is doped with the electrolyte in an amount of about 5 mg/cm² to 9 mg/cm².

11. The method of claim 1, wherein the electrolyte membrane has a thickness of about 40 μm to 50 μm, and the electrode layer has a thickness of about 5.5 μm to 55 μm.

12. The method of claim 1, the electrode layer of the laminate is transferred to the electrolyte membrane at about 120° C. to 140° C. to manufacture the membrane-electrode assembly.

13. The method of claim 1, wherein the electrode layer of the laminate is transferred to the electrolyte membrane at a pressure of more than about 3.89 MPa to 5.84 MPa or less to manufacture the membrane-electrode assembly.

14. A membrane-electrode assembly for a polymer electrolyte membrane fuel cell, the membrane-electrode assembly comprising: an electrolyte membrane; and an electrode layer on the electrolyte membrane, wherein the electrolyte membrane comprises a substrate and an electrolyte doped into the substrate and is in the form of a catalyst-coated membrane (CCM).

15. The membrane-electrode assembly of claim 14, wherein the electrolyte membrane has a thickness of about 40 μm to 50 μm, and the electrode layer has a thickness of about 5.5 μm to 55μ m.

16. The membrane-electrode assembly of claim 14, wherein the substrate has a binding energy for phosphoric acid of about 100 kcal/mol or more.

17. The membrane-electrode assembly of claim 16, wherein the substrate comprises a hydrocarbon-based polymer having a quaternary ammonium group, optionally one selected from the group consisting of phosphonated phenylated-poly(phenylene), phosphonated polynorbornene, phosphonated polycarbazole, and a combination thereof, and the electrolyte includes phosphoric acid.

18. The membrane-electrode assembly of claim 14, wherein the electrolyte membrane is one in which the substrate is doped with the electrolyte in an amount of about 5 mg/cm² to 9 mg/cm².

19. The membrane-electrode assembly of claim 14, wherein the electrode layer comprises a catalyst and an ionomer, and the ionomer comprises a perfluorosulfonic acid-based ionomer, a partial fluorophosphate-based ionomer, or a combination thereof.

20. The membrane-electrode assembly of claim 14, having a high-frequency resistance (HFR) of about 100 mΩ·cm² or less.
